(19) United States
(12) Patent Application Publication
(10) Pub. No.: US 2025/0254039 A1
(43) Pub. Date: Aug. 7, 2025

(54) SYSTEM AND METHOD FOR DYNAMICALLY SETTING DATA CAPACITY IN ONE OR MORE WIRELESS NETWORK DEVICES

(71) Applicant: Trango Networks, LLC, Random Lake, WI (US)

(72) Inventor: Christopher A. GUSTAF, San Diego, CA (US)

(21) Appl. No.: 19/047,384

(22) Filed: Feb. 6, 2025

Related U.S. Application Data
(60) Provisional application No. 63/550,326, filed on Feb. 6, 2024.

(51) Int. Cl. H04L 9/08

(52) U.S. Cl. CPC H04L 9/0894

(57) ABSTRACT

A method for setting data capacity limits in a network device by providing a license key having a network device address and ingress and egress data capacity information, determining if the stored network device address matches a network device address in the license key, if the stored network device address matches the network device address in the license key, downloading the license key and storing the license key in memory, applying one or more decryption techniques to the license key to decrypt the license key, and applying the ingress and egress data capacity limits to the network device.

### RELATED APPLICATION

The present application claims priority to U.S. provisional patent application Ser. No. 63/550,326, filed on Feb. 6, 2024, and entitled Method For Dynamically Setting Port Specific Capacity In One Or More Wireless Network Devices, the contents of which are herein incorporated by reference.

### BACKGROUND OF THE INVENTION

Wireless point to point links are commonly used for Internet access to networks where traffic follows an asymmetric pattern typified by download traffic being much higher than upload traffic. The prevailing model for microwave point to point networks is to purchase the hardware at full price and pay for capacity keys that are stored in non-volatile memory. This highly cost inefficient.

Wireless point-to-point (PtP) links are widely known and used to provide Internet access and network connectivity, particularly in areas where traditional wired infrastructure is impractical or cost prohibitive. The PtP links are commonly deployed in environments where network traffic exhibits an asymmetric pattern, with download traffic significantly exceeding upload traffic. Such traffic asymmetry is particularly evident in applications such as residential broadband services, video streaming, and cloud-based computing, where end users predominantly consume content rather than upload large volumes of data.

Traditional microwave PtP networks operate under a prevailing business model that requires customers to purchase hardware at full price, often involving substantial upfront capital expenditures. Additionally, these systems employ a licensing structure where capacity keys, stored in non-volatile memory, dictate the maximum throughput of the link. These capacity keys are typically purchased separately, effectively gating network performance based on a predefined licensing tier.

This approach presents several disadvantages. First, it is highly cost-inefficient, as customers typically need to invest in expensive hardware with capabilities that exceed their immediate requirements, leading to underutilization of network resources. Second, the licensing model imposes rigid constraints on network scalability, requiring additional expenditure whenever an increase in capacity is needed. Furthermore, storing capacity keys in non-volatile memory introduces risks related to hardware failure, security vulnerabilities, and operational complexity in managing licensing across multiple network nodes.

### SUMMARY OF THE INVENTION

Given the foregoing inefficiencies and constraints of the traditional microwave PtP networks, there is a need in the art for systems and methods that optimize cost efficiency, enhance scalability, and provide greater flexibility in managing network capacity.

The present invention is directed to a network communication system that employs a network device that allows a user to select or adjust the data rate and data capacity of their network device, thus paying only for data usage which can be beneficial in reducing operating costs. The present invention allows for independently controlling the data capacity in the upstream and downstream directions in a network device. Using a subscription-based model, the hardware (e.g., network device) can be offered at very low or no cost, and the end-user (e.g., customer or internet service provider (ISP)) only pays for the data capacity needed. The end-user can increase or decrease the data capacity or data rates in real time with no interruption to data traffic or service. With this model, the operating expenses can be matched to the actual data traffic demand, saving the end-user money. The network device can be configured to allow the user to select and limit the data capacity and/or data rate by providing information to a license server that is added to a license key file that is stored therein, and by retrieving and processing the license key file. The license key file can be optionally encrypted and can include selected types of information, such as the ingress and egress data capacity limits for the network device on the network-facing physical traffic interfaces. The data capacities can be changed at any time by the end-user. The data capacity refers to the total amount of data that a network device can handle and process within a given timeframe. The data rate (e.g., bandwidth or throughput) refers to the speed at which data is transmitted over a network or communication channel and is measured in bits per second.

The network device can be configured to check on a periodic basis (e.g., daily) to make sure that a valid license key is present and then adjust the allowed data capacity for each interface based on the contents of the license key. Each traffic interface can be assigned to a different end-user to allow sharing of the system. If the network device cannot access the server for a specified period of time, the network device can restrict the data capacity to a low fixed amount of data to allow traffic to flow at a reduced rate. The network device can report the daily usage automatically so that the end user can determine if a change in licensed capacity is needed.

The present invention is directed to a network communication system comprising a network, a server coupled to the network for storing a license key file having a license key, and a first network device coupled to the network. The first network device includes a switching assembly having a plurality of ports for managing and routing data, a modem module for receiving the data from the switching assembly and then modulating the data to generate modem data, a radiofrequency assembly for receiving the modem data and then transmitting the modem data over the network, and a controller for controlling the first network device and for storing the license key. The controller can be configured to store and apply a decryption technique to the license key to generate a decrypted license key. The license key can include selected types of information, optionally stored in data fields, including media access control (MAC) address data associated with the first network device, ingress data capacity or data rate limits associated with one or more of the plurality of ports, egress data capacity or data rate limits associated with the modem module, and priority data associated with one or more of the plurality of ports. The first network device is a microwave network device.

The present invention is also directed to a method for setting data capacity limits in a network device, the network device having a switching assembly having a plurality of ports for managing and routing data, a modem module for receiving the data from the switching assembly and then modulating the data to generate modem data, a radiofrequency assembly for receiving the modem data and then transmitting the modem data over the network, and a controller for controlling the first network device and for storing in memory the license key and a network device address. The method comprises providing a license key having a network device address and ingress and egress data capacity information, determining if the stored network device address matches a network device address in the license key, if the stored network device address matches the network device address in the license key, downloading the license key and storing the license key in the memory, applying one or more decryption techniques to the license key to decrypt the license key, and applying the ingress and egress data capacity limits to the network device. The license key can include data priority information, and the method includes applying the data priority information to the plurality of ports.

The method also includes performing a boot up sequence for the controller and then determining whether the network device retrieves a license key from a remote server or from the memory, determining if the license key is stored in the remote server, and downloading the license key from the remote server if stored therein. If the license key is not stored in the remote server, incrementing a counter indicative of the number of attempts made to download the license key, and determining at a later time whether the license key is stored in the remote server. When the counter exceeds a threshold level, setting an egress data capacity of the network capacity to a predetermined level. The method also includes providing an account management software application for enabling a user to set the egress data capacity limit and the ingress data capacity limit for storage in the license key.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1 is a schematic block diagram of a network communication system employing a network device according to the teachings of the present invention.

FIG. 2 is a schematic block diagram of the network device of the network communication system of FIG. 1 according to the teachings of the present invention.

FIG. 3 is a schematic block diagram of the communication between network devices of the network communication system according to the teachings of the present invention.

FIG. 4 is a schematic representation of a data structure, such as a license key, of the license key file according to the teachings of the present invention.

FIG. 5 is a schematic flow chart illustrating the method for downloading the license key file from a server according to the teachings of the present invention.

FIG. 6 is a schematic flow chart diagram of the process for checking and retrieving the license key file by a network device according to the teachings of the present invention.

### DETAILED DESCRIPTION OF THE INVENTION

The present invention is directed to a network communication system that enables a network device to communicate with another network device over a wide area network while configuring or adjusting one or more of the network devices to upload or download data at user adjustable levels.

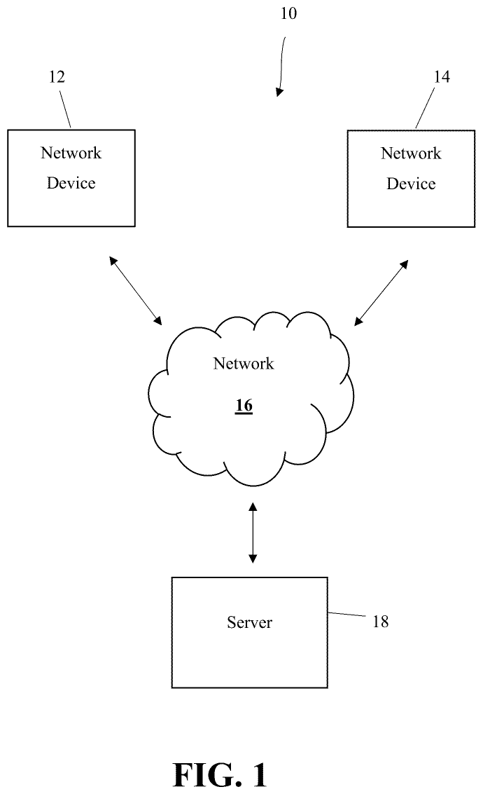

FIG. 1 is a schematic block diagram showing the network communication system 10 of the present invention. The illustrated network communication system 10 includes a first network device 12 that communicates with a second network device 14 over a network 16. The network can be representative of a wide area network (WAN, a local area network (LAN), or a metropolitan area network (MAN). The network devices can exchange or retrieve information from a server 18 that communicates with the network devices over the network. The network devices can be an electronic apparatus or device that is configured to facilitate, manage, or optimize communication within the network 16 by transmitting, receiving, switching, routing, processing, or controlling data, voice, or video signals. The network devices can operate within a wired, wireless, optical, or hybrid communication system and can include integrated or modular components, such as processors, memory, transceivers, switching modules, network interfaces, and the like. Examples of suitable network devices include routers, switches, modems, access points, network interface devices, microwave network devices, load balancers, base stations, terminals (e.g., optical network terminals), and the like. According to one embodiment, the network devices can be microwave network devices. The microwave network devices 12, 14 can be an electronic apparatus that are configured to facilitate high-frequency wireless communication by transmitting, receiving, processing, and managing data signals within the microwave spectrum (e.g., 1 GHz to 100 GHz). The microwave network devices enable point-to-point, point-to-multipoint, or backhaul communication in wireless networks, utilizing components such as radio frequency (RF) transceivers, receivers, transmitters, modulators, demodulators, antennas, signal processing units, and the like. Microwave network devices can incorporate advanced modulation techniques, adaptive power control, error correction mechanisms, and networking protocols to optimize signal transmission, mitigate interference, and ensure reliable connectivity across varying environmental conditions. The network communication system 10 can also include a server 18 that can be configured for storing licensing related data, such as licensing keys and the like.

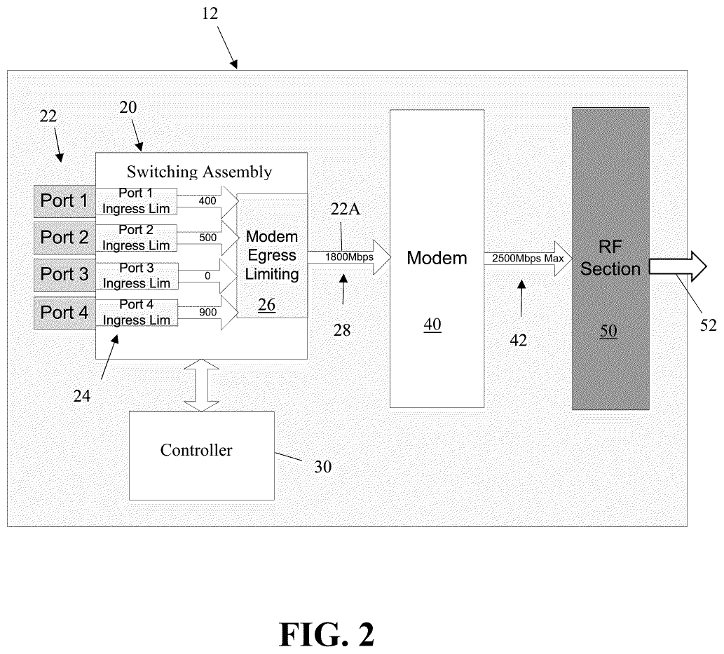

FIG. 2 is a schematic block diagram of an example network device according to the teachings of the present invention. The network devices 12, 14 can be similar in structure and function, and for the sake of simplicity, the network device 12 is described herein. The network device 12 can be configured to allow the user to adjust or restrict the upload and download data rates and the overall data capacity of the device. The illustrated network device 12 can include a switching assembly or portion 20 that can be configured for managing the routing and distribution of data across network paths and for ensuring efficient data transmission by directing traffic based on network conditions, protocols, and priorities. The switching assembly 20 can be employed in digital microwave systems to divide the data into packets and then transfer the data packets over the network 16 to be reassembled at the destination. The switching assembly 20 can also dynamically select the best available path for data transmission based on network conditions, and as such, can perform a selected degree of load balancing so as to ensure that network traffic is evenly distributed to avoid congestion and maximize efficiency. The switching assembly 20 can also ensure that different types of data traffic are prioritized based on network policies and conditions. The switching assembly 20 can have a plurality of ports 22 associated therewith. The data exchanged by the device happens through the ports 22. According to one embodiment, the data is received or transmitted through the ports as electromagnetic signals that carry information that is encoded using various modulation techniques. The ports 22 thus serve as physical and electrical interfaces that allow signals to enter or exit the network device. Each of the ports 22 can be assigned or associated with a specific end user. The switching section can include an optional port ingress limiter unit 24 associated with each port 22. The port ingress limiter 24 can help control, manage and limit incoming data traffic on a specific port 22 of the network device. This helps regulate or limit the data capacity or data rate (e.g., bandwidth usage), prevent congestion, and enhance security. According to one embodiment, the port ingress limiter 24 can limit or monitor the rate of data flow across the port and limit the data flow according to one or more data policies. The port ingress limiter 24 can be implemented at the port-level or can be implemented as part of the controller 30. The switching assembly 20 can also include an optional modem data limiter (e.g., egress limiter) 26 for controlling, restricting, limiting, or managing the rate of data flow between the modem module 40 and the network 16. The modem data limiter 26 can regulate, restrict, or limit the data flow or bandwidth to a modem module 40 to prevent congestion or abuse or to be consistent or to comply with the data terms in a license key file. More specifically, the modem data limiter 26 can limit the data capacity of the network device 12. The modem data limiter 26 can be implemented as part of the modem hardware or can be implemented by a separate controller, such as by the controller 30. The switching assembly 20 can generate combined or total data 24 that corresponds to the total of the ingress data passing along or through each port 22. The total data 28 can pass along the common port 22A.

The network device 12 can also include a controller 30 having a processor and memory for storing suitable software applications and licensing key related data. The controller 30 can function as the central processing unit (CPU) of the microwave network device 12 by controlling and managing the network device. Specifically, the controller 30 can manage the overall device coordination, performance monitoring, and communication between different sections of the network device, as well as between multiple components of the network communication system 10. The controller 30 can also control and synchronize the operation of one or more of the switching assembly, the modem module and the radiofrequency assembly. The controller 30 can store for example in suitable memory operating system software applications, account management software applications, firmware, decryption software applications, license key files and associated license keys, network device address information (e.g., a media access control address (MAC) and the like). The controller 30 can communicate with the server 18. According to one embodiment, the server 18 can be a read-only file server with read only rights for end users. The controller 30 can store suitable account management software that has write privileges and writes, removes and updates license key file data for one or more of the network devices that are under an active license subscription. The server 18 can be located on a public IP address so that all the devices with Internet access can access or communicate with the server 18. The account management software application allows the customer or user to create accounts, add user identification information, add network devices, and establish data capacity and data rate limits for the network devices 12, 14 that form part of the license key file. The account management software also allows the customer to enter payment information (e.g., credit card data) to enable payments based on the data capacity and/or data rates that the user selects. As used herein, firmware refers to a specific class of computer software program that is embedded in a hardware device and provides low-level control over the function of the hardware. The software program is typically stored in the memory and is executed by the processor. The firmware serves as an intermediary between the hardware and higher-level software programs, enabling the operation, configuration, and management of the controller (e.g., processor) and hence of the network device. The firmware can include boot processes or sequences, system control instructions, and functional logic specific to the hardware. The account management software can refer to a computer-implemented system or software application that facilitates the creation, maintenance, authentication, and/or control of user accounts. The account management software enables user to create, manage, revise, store, and retrieve account-related data, including for example user identification information, payment data, credentials, permissions, access logs, and activity history. The account management software can incorporate authentication protocols, encryption mechanisms, and role-based access control to ensure secure interactions with associated systems or devices. In the context of providing information associated with a network device, the account management software can authenticate users, manage access rights, and allow the user to manage and control data capacity and/or date rates, establish data or port priorities, and/or log interactions with network-connected hardware. The account management software can facilitate the retrieval of configuration data, performance metrics, security settings, or usage history related to the network device.

The illustrated network device 12 can also include a modem module 40 for converting digital or analog baseband signals into modulated signals (e.g., modulated data) suitable for microwave transmission and can extract the original baseband signal from received microwave signals into demodulated signals (e.g., demodulated data). Specifically, the modem module 40 can be configured to process digital or analog signals or data (e.g., the total data 28) for transmission and reception over a suitable microwave link, and can encode and decode the data, ensuring the correct signal format for transmission. The modem module 40 also ensures efficient data encoding, error correction, and synchronization for reliable communication over microwave links and the network 16. The modem module can also include a dedicated processor to handle signal processing, modulation, and error correction efficiently. The modem module can generate modem data 42.

The network device 12 can further include a radiofrequency (RF) assembly 50 for receiving and transmitting the modem data 42. Specifically, the radiofrequency assembly 50 can be configured for generating, amplifying, transmitting, and/or receiving microwave signals. The RF assembly 50 handles the conversion between baseband signals (low-frequency) and high-frequency microwave signals for transmission. The RF assembly 50 can include a transmitter for converting the baseband signals or modem data from the modem module 40 into RF frequencies and can amplify the signals for transmission via a suitable antenna. The RF assembly 50 can also include a receiver for capturing RF signals from the antenna from another network interface device and can down convert the signals to lower frequencies for further processing by the modem module 40. The RF assembly 50 can generate RF data 52 that is transmitted along the network 16, and preferably to another network device 14.

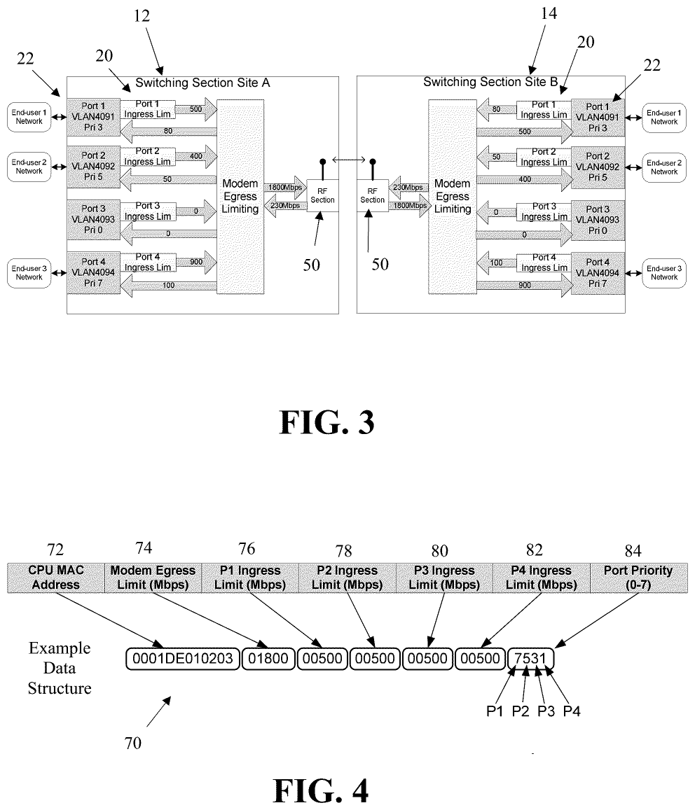

FIG. 3 is a schematic system diagram showing the communication that can occur between a pair of network devices 12, 14, such as a pair of microwave network devices, over the network 16. The network devices are illustrated in a simplified form for ease of understanding. The network devices 12, 14 can communicate with each other via the network 16 and can communicate with each other wirelessly to enable two-way communication. Each of the network devices can also employ their own controller 30 to manage the licensing key files independently of each other.

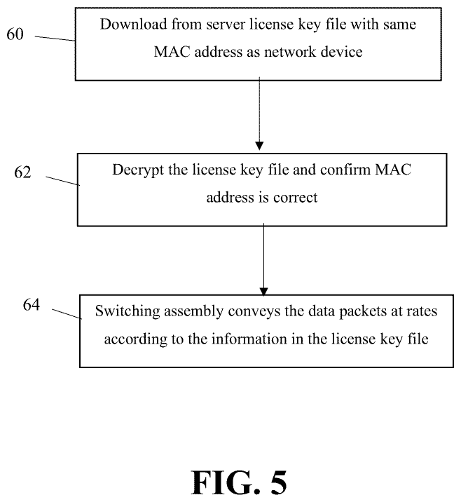

The controller 30 of the network device 12 can have stored therein operating system software, firmware, account management software, decryption software, any downloaded license key file and associated license key, device address information, and the like. According to one embodiment, as shown for example in FIG. 5, the controller 30 communicates with the server 18 over the network 16 and determines if the server 18 has stored therein a license key file that includes license key with associated license key data that corresponds to the network device 12. The license key file can be a structured digital file or data string that grants the network device access to specific features, functionalities, information, or software modules. The structure and content of the license key file can vary based on the vendor and licensing model, but can include for example a license key having header information (e.g., product name, vendor information, license version, and the like), device specific information (e.g., address information such as a media access control (MAC) address, serial number or the like, as well as system or host information), license related information, ingress data rate and/or data capacity information, egress data rate and/or data capacity information, security information, port or data priority information, metadata, and the like.

According to one embodiment, the controller 30 can download the license key file from the server 18 if the MAC address information in the license key file matches the MAC address of the network device 12, step 60. The MAC address is a unique identifier assigned to the network device 12 and is used for communication within a network 16, such as a local area network or a wide area network (e.g., Internet). If the license key file has a MAC address that matches the address of the network device 12, the contents of the license key file are downloaded and decrypted using one or more selected decryption techniques, such as by using SHA256 or similar hashing algorithms optionally combined with one or more non-public secret codes. After the license key file is decrypted, the controller 30 determines if the MAC address in the key matches the MAC address of the network device to indicate that the license key file is correct, step 62. If the MAC address does not match the MAC address of the network address, the license key file is not processed further and is subsequently discarded. If the MAC addresses in the license key match the MAC address of the network device, then the controller 30 processes the information stored in the license key file and applies the ingress and egress data capacity limits stored in the license key.

The switching assembly 20 transports or conveys the data packets in the total data 24 from one of multiple input ports 22 (e.g., Ports 1-4) along an optional common data port 22A that communicates with the modem module 40 according to the information contained with the license key file, step 64. Alternatively, the switching assembly 20 can employ a series of dedicated uplinks to the modem module 40, where each port 22 can have its own dedicated channel or virtualized path within a higher-bandwidth internal connection. The input ports 22 can have a port network (e.g., port VLAN) assigned thereto and the switching assembly 20 can add a network tag or identification information (e.g., a VLAN tag) to allow for mapping any given port on one device to the port with the same port identification information on another network device. The network tag can optionally include a priority field that determines which data packets arriving on each data port 22 is forwarded in the event of congestion or egress limiting into the modem module 40 by the modem data limiter 26.

The decrypted license key file can include selected data fields representing selected types of information, such as for example the ingress data rate or data capacity limits for each data port 22, an egress data limit (e.g., data capacity limit) to be applied by the modem data limiter 26 for the common data port 22A, and a priority field to assign data priority to the data passing through the ingress ports 22 in the case of data congestion or traffic. The controller 30 can process the ingress data field information values by setting or establishing via the port ingress limiter 24 an ingress data limit per port to limit the incoming data capacity on a port by port basis. The controller 30 can also set the egress data limit out of the switch assembly 20 via the modem data limiter 26 into the modem module 40 to ensure that no more than the maximum licensed data capacity and data rate is being sent. The egress rate of the modem module 40 is typically set to equal the sum of the ingress data rates and data capacity of all ports 22 but can be less than the sum of the ingress data rates if oversubscription of each port 22 is desired. In the oversubscription case, the port priority field of the license key file can optionally determine the ports that receive priority over the other ports in sharing the egress capacity limit into the modem module 40. The data rates in the network device or over the network 16 refer to the speed at which data is transmitted and received over the network connection per unit of time. The data rates can be measured in bits per second (bps) and determine the performance of the network devices, interfaces, links, and overall traffic flow. The ingress data rate is the speed at which data enters a network device or interface over a port 22. The egress data rate is the speed at which data exits the network device 12. The switching assembly 20 can optionally employ a selectable scheduler employing a scheduling technique to process the data packets when processing the priority field data to determine which data packets have priority or may be dropped. The scheduling techniques can be used to manage how data packets are queued and transmitted so as to ensure efficient traffic flow, prevent data congestion, and prioritize data. The scheduling techniques can include, for example, a Weighted Round Robin (WRR) strict, Weighted Random Early Detection (WRED), strict priority scheduling, and the like. The WRR technique can distributes bandwidth among different queues or ports based on assigned weights. Each queue receives a turn to send data packets, but queues with higher weights send more data per cycle than the queues with lower rates. This type of weighted scheduling technique helps prevent low-priority traffic from being starved while ensuring high-priority traffic gets more resources. The WRED technique prevents congestion by selectively dropping data packets before the queue is full. For example, the controller employing this technique can drop lower-priority data packets randomly based on weight, thus allowing high-priority traffic to flow smoothly. The strict priority scheduling always serves the highest-priority queue first before moving to lower-priority queues. The lower-priority data traffic only gets processed if the higher-priority queues are empty.

The modem module 40 encodes the incoming data packets from the ports and modulates the data packets onto a data carrier to be transmitted to a second system or network device that receives the data packets. Depending on the data modulation level, the actual data capacity of the output of the radiofrequency section 50 of the network device 12 can be limited or constrained by the limiters 24, 26 to a level below the data egress capacity. In this example, data flow control can be used between the modem module 40 and the switch assembly 20 to ensure that the data packets are processed by the switch assembly 20 according to selected settings, including for example a quality of service (QoS) settings, and are in part defined by the priority field in the license key file. The RF assembly 50 can translate the output of the modem module 40 up to a selected radio frequency level and can optionally filter the data stream and control the power level.

With reference to FIGS. 1-3, the output data 52 of the RF assembly 50, and hence of the network device 12, can be conveyed to a second network device 14 over the network 16. At the second network device 14, the data processing method is reversed, but there is optionally no data rate or capacity limiting techniques applied to the incoming data. The data packets received are received by the RF section 50, forwarded to the modem module 40, and then forwarded from the modem module 40 to the switching assembly 20, where the data packets are routed to the port 22 with the matching port ID (e.g., port VLAN ID). Since the sum total capacity of the received data is always less than the sum of all the customer facing ports, there is no need to restrict the data as it exits the network device 12 and enters the other network device 14. For example, as shown in FIGS. 2 and 3, the data associated with ports 22 (e.g., Ports 1-4) are limited by the port ingress limiters 24 to the data capacity and/or data rates limits defined in the license key file or otherwise implemented by the controller 30 based on applicable data policies. For purposes of clarity and by way of simple example, Port 1 is conveying data at a 500 Mbps data rate, Port 2 is conveying data at a 400 Mbps data rate, Port 3 is conveying data at a 0 Mbps data rate, and Port 4 is conveying data at a 900 Mbps data rate. The combine data rates traveling over the common port 22A are thus 1800 Mbps, which can be selectively further limited if desired by the modem data limiter 26. The output data 52 conveys the 1800 Mbps data rate to the network device 14, where the data is then sent to selected ports, via port ID information, and at the same data rates.

FIG. 4 is one example of the data structure of a license key forming part of the license key file according to the teachings of the present invention. Those of ordinary skill in the art will readily recognize that the illustrated license key is merely one example of the license key and that other forms, types, or arrangement of data can be employed. The illustrated example license key 70 can have a data string format where the initial portion of the data string corresponds to the address 72 of the network device 12 (e.g., MAC address), the next portion of the data string 74 corresponds to the modem egress data limit that can be applied to the data by modem data limiter 26 (in Mbps), the next data string portion 76 corresponds to the data ingress limit of Port 1 (e.g., 500 Mbps), the next data string portion 78 corresponds to the data ingress limit of Port 2 (e.g., 500 Mbps), the next data string portion 80 corresponds to the data ingress limit of Port 3 (e.g., 500 Mbps), the next data string portion 82 corresponds to the data ingress limit of Port 4 (e.g., 500 Mbps), and then the last data string portion 84 corresponds to priority values assigned to each port (e.g., port VLAN tag priority field). The modem data limiter 26 can confine, restrict, or limit the data rate of the data passing along the common data port 22A as defined by the license key information 74. In the illustrated example, the egress data limit is 1800 Mbps.

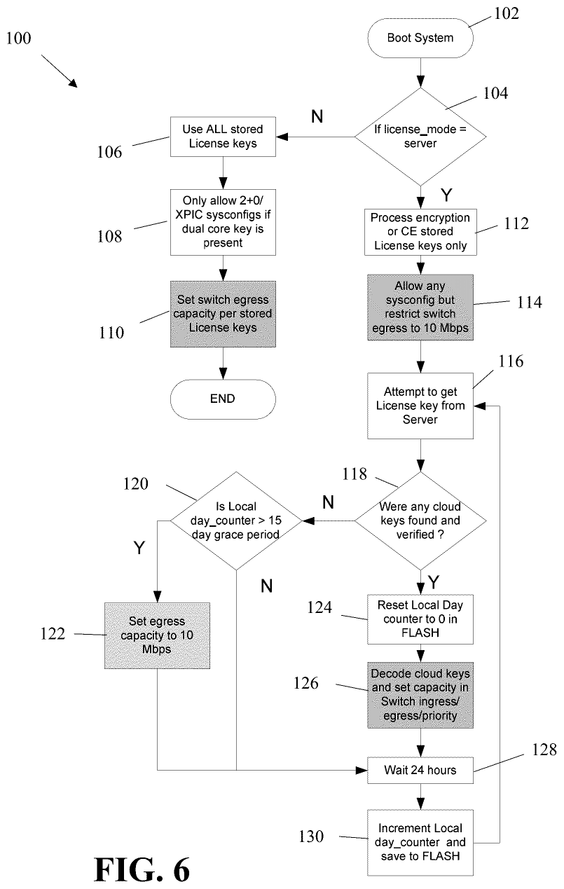

In operation, the network communication 10 of the present invention can employ one or more network devices that retrieve a license key file associated with the device from a storage or license server 18. The license key file can include the license key 70 that has data fields that include the address (e.g., MAC address) of the network device and the data rate limits that can be applied by the port ingress limiters 24 and the modem data limiter 26. The data rate limiters can be customizable by the user so that the user can pay for the data rates that align best with the user's needs. FIG. 6 is a schematic flow chart showing the method employed by the network communication system 10. The network device 12 can boot up and the controller 30 can process any selected software applications, step 102. The controller 30 then determines whether the network device 12 is a stand-along device or is part of a license-server based system that needs to retrieve a licensing key file from the remote licensing server 18, step 104. If the network device 12 is a stand-alone device, then the controller processes any prestored license key file data, step 106. The controller 30 can then process the licensing key file that can include system configuration information and restrictions related to device and system set-up. The system 10 can initiate a redundant set-up of a pair of microwave network devices (e.g., 2+0 configuration) in a non-diverse (e.g., 0) configuration. Specifically, and according to one embodiment, the network devices 12, 14 can be arranged in parallel but are not configured for diversity (e.g., they do not automatically switch between each other in the event of failure). This system configuration and setup helps increase system capacity and redundancy. The network communication system 10 can also employ a Cross-Polarization Interference Canceller (XPIC) used in microwave communications to allow two signals with different polarizations to be transmitted simultaneously over the same frequency channel without causing interference. This allows for more efficient use of the frequency spectrum. The stored license key file can include information that unlocks the ability to use dual-core processors or dual-core configurations in the microwave network device. The dual-core processor setup helps handle the increased processing load and complexity that comes with a 2+0/xpic sysconfiguration set-up, step 108. Consequently, in this example embodiment, the network device 12 only allows configuration of the network devices in a 2+0 setup with XPIC if the dual-core key is present in the license key file and activated in the network communication system 10. This ensures that the network communication system 10 has the necessary resources to handle the complexity and demand of such a configuration. The license key file can also set the egress data capacity of the network device 12 per stored license key data. That is, the data capacity of the data transmission (egress) leaving the network device 12, through the switching section 20, is controlled or limited based on the license key data that are stored in the controller 30. Egress refers to outgoing data traffic sent from the network device 12 to another network device. The controller 30 can process the license key forming part of the licensing key file data to determine how much egress traffic can be forwarded through the switch section 20, step 110.

If the controller 30 determines that the network device 12 is a server based system, then the controller 30, through suitable firmware or other software application programs, connects to and communicates with the license server 18 to establish a communication connection using a suitable secure connection protocol, such as a secure file transfer protocol (SFTP). The license server network address and credentials are stored in the controller 30. If the connection is established, the controller 30 can attempt to transfer a license key file with a predetermined filename containing the MAC address of the network device. The attempt to download the license key file from the license server 18 can occur any number of times within a given time period, such as for example at least once per day. If the license key file is present in the server 18 and downloaded to the network device 12, the license key file is then decrypted by the controller and processed as described herein, step 112. The controller 30 then restricts the total egress data capacity of the network device 12 to a predetermined value to allow a connection for management and connection to a WAN (e.g., the Internet), but not to be used as a high speed communication link, step 114. The network device continues to attempt to retrieve a license key file from the server 18, step 116. The controller 30 then determines if a license key file was found, step 118. If the license key file is not present or stored in the server, then the controller increments a counter (e.g., a day counter) indicating that no key was found, step 120. The firmware then attempts to contact and download the key at least once per day. If successful, the day counter is reset to 0. If not, the firmware continues to check at an increasingly frequent rate (e.g., multiple times per day). For every day that passes without the license key file being found on the server 18, the day counter is incremented and saved to memory in the controller 30. If the day counter exceeds a set threshold, called the grace period, the egress data capacity of the network device 12 is restricted to a selected level, such as for example 10 Mbps. The day counter can be saved to memory in the controller 30 in order to prevent an end-user from simply rebooting the network device to reset the counter to 0. If the license key file is found in the server 18, then the controller 30 sets the counter to zero, step 124. The controller then decrypts and decodes the license key file and sets the ingress and egress data capacities and/or data rates of the network device 12, as well as the priorities of the ports, based on the license key information, step 126. The controller then waits a selected period or amount of time (e.g., 24 hours), step 128. The controller 30 then increments the counter and saves the counter to memory, step 130. The controller then once again attempts to retrieve the license key file from the server 18, step 116. This allows the controller to check that the customer payment is up to date and to see if any capacity restriction changes were made by the customer.

The account management software stored in the controller 30 allows the customer to create an account and to adjust the data capacity on the network device. This, in turn, adjusts the data in the license key file. The user pays a fee (e.g., a monthly fee) based on the amount of data capacity that they select. Each customer has a unique account number that allows the customer to manage their network devices. After the customer purchases the network device, the customer enters the device MAC address and the port capacity and priority information into the account management software. The corresponding monthly rate is displayed and accepted by the customer. The account management software then prompts the customer for payment information which is subsequently verified. The account management software generates the encrypted license key file and transfers it to the license server upon successful payment of the first month's fee. Every month when the credit card is processed, the license key file is either left stored in the server 18 if the payment is successful or removed from the server 18 for non-payment.

The illustrated network devices can also include additional components, such as power supplies (e.g., DC-DC power supplies or converters) and selected types of memory (e.g., flash memory). The modem module 40 can optionally be a full duplex modem with intermediate frequencies of about 100 to about 1000 MHz, and the radiofrequency assembly can operate between about 1 to about 100 GHz to provide for transmitting and receiving network traffic wirelessly. The controller 30 can store suitable firmware in memory (e.g., flash memory) that periodically attempts to download a license key file from the server 18 and sets the network device ingress and egress capacity values for each port to restrict the total data capacity entering the modem module 40. In addition, the firmware sets all the radiofrequency assembly 50 and modem module 40 operating parameters and provides a user management interface. The firmware can run on a standard operating system, such as Linux, and the switching assembly 20 can optionally have its own firmware and operating system stored in local memory and processed by its own controller that is suitable for handling low level switch hardware register settings. The switching assembly firmware communicates with the controller 30 to make changes to the ingress and egress data rates for each por. The modem port can be optionally fixed at a selected rate, such as for example at a rate of 2500 Mbps.

The controller 30 can also employ a decryption engine for decrypting the license key file and can store encrypted private secrets used in the decryption of the license key files. A license-mode flag or tag (or other identification information) can also be stored in the memory of the controller 30 that indicates the licensing model employed by the network device. By simple way of example, if the license-mode flag is set to 1, then the network device 12 can attempt to download the remote license key file from the server 18 and ignore any locally stored perpetual capacity related license keys except for an encryption key and a carrier ethernet switch key. These two keys unlock features that are independent of capacity limiting and therefore are used regardless of the license type or mode. If the license-mode flag is set to 0, then the network device 12 only looks for the perpetual keys stored in memory and does not attempt to contact the server 18. The controller 30 can restrict capacity to a minimal amount if a valid key is not found and keeps a day counter to allow a grace period if the license key file was found at least one time but subsequently was not found.

The account management software program can be a web-based software having a graphical user interface that allows the customer to create user accounts with usernames and passwords, then add network devices they wish to control by entering the MAC address of the device. After the device is added to the account, the user can select the capacity license for the device and each of its ports by choosing a plan from a dropdown menu. The software program also allows the customer to enter payment information, such as a credit card number, and other details to enable automatic monthly fee payments based on the plan that they select, then saves the information. The software program also allows each customer to have a unique account that allows them to manage their devices, and many customers can be on the same server without seeing any information about other customers. The account management software can generate the encrypted license key file and transfer the file to the license server 18 upon successful payment of the first month's fee. Every month when the credit card is processed, the license key file is either left in the server if the payment is successful or removed from the server for non-payment.

The present invention is essentially directed to a wireless data transport system employing multiple network devices, each comprised of a switching assembly, modem module, and radiofrequency assembly, configured to automatically obtain and decrypt an encrypted license key from a remote server on a wide area network. The license key file can include a license key having ingress data capacity limits for each traffic interface (e.g., port) as well as the total egress data capacity limit into the modem module. The controller can employ account management software for allowing the user to set the data capacity limits in real time and on-demand. The license key can include the unique MAC address of the network device to validate the license key. The license key can include an additional data field setting forth the priority of the data traffic on the user ports to give preference to forwarding traffic from specific ports in the presence of switch congestion due to radio capacity restrictions or over subscription.

The license keys are separate for each traffic interface and can be assigned to different end users. The sum of all the data for all of the ports is not more than a maximum allowable nominal capacity of the network device. The network device can monitor and report the percentage of the egress data capacity used each day and suggest changes if capacity is nearing the maximum provisioned data capacity.

It will thus be seen that the invention efficiently attains the objects set forth above, among those made apparent from the preceding description. Since certain changes may be made in the above constructions without departing from the scope of the invention, it is intended that all matter contained in the above description or shown in the accompanying drawings be interpreted as illustrative and not in a limiting sense.

It is also to be understood that the following claims are to cover all generic and specific features of the invention described herein, and all statements of the scope of the invention which, as a matter of language, might be said to fall therebetween.

I claim:

1. A network communication system, comprising
a network,
a server coupled to the network for storing a license key file having a license key, and
a first network device coupled to the network having
a switching assembly having a plurality of ports for managing and routing data,
a modem module for receiving the data from the switching assembly and then modulating the data to generate modem data,
a radiofrequency assembly for receiving the modem data and then transmitting the modem data over the network, and
a controller for controlling the first network device and for storing the license key.

2. The system of claim 1, wherein the controller applies a decryption technique to the license key to generate a decrypted license key.

3. The system of claim 1, wherein the license key includes media access control (MAC) address data associated with the first network device, ingress data capacity or data rate limits associated with one or more of the plurality of ports, egress data capacity or data rate limits associated with the modem module, and priority data associated with one or more of the plurality of ports.

4. The system of claim 1, wherein the first network device is a microwave network device.

5. A method for setting data capacity limits in a network device, the network device having
a switching assembly having a plurality of ports for managing and routing data,
a modem module for receiving the data from the switching assembly and then modulating the data to generate modem data,
a radiofrequency assembly for receiving the modem data and then transmitting the modem data over the network, and
a controller for controlling the first network device and for storing in memory the license key and a network device address,
the method comprising,
providing a license key having a network device address and ingress and egress data capacity information,
determining if the stored network device address matches a network device address in the license key,
if the stored network device address matches the network device address in the license key, downloading the license key and storing the license key in the memory,
applying one or more decryption techniques to the license key to decrypt the license key, and
applying the ingress and egress data capacity limits to the network device.

6. The method of claim 5, wherein the license key includes data priority information, further comprising applying the data priority information to the plurality of ports.

7. The method of claim 6, further comprising
performing a boot up sequence for the controller and then determining whether the network device retrieves a license key from a remote server or from the memory,
determining if the license key is stored in the remote server, and
downloading the license key from the remote server if stored therein.

8. The method of claim 7, further comprising, if the license key is not stored in the remote server,
incrementing a counter indicative of the number of attempts made to download the license key, and
determining at a later time whether the license key is stored in the remote server.

9. The method of claim 8, further comprising, when the counter exceeds a threshold level, setting an egress data capacity of the network capacity to a predetermined level.

10. The method of claim 9, further comprising providing an account management software application for enabling a user to set the egress data capacity limit and the ingress data capacity limit for storage in the license key.
